(19) United States
(12) Patent Application Publication
(10) Pub. No.: US 2017/0122567 A1
(43) Pub. Date: May 4, 2017

(54) PARK-STYLE GRILL SHELF

(71) Applicant: NICHOLAS HORTON, CRESCENT, OK (US)

(72) Inventor: NICHOLAS HORTON, CRESCENT, OK (US)

(21) Appl. No.: 15/342,804

(22) Filed: Nov. 3, 2016

Related U.S. Application Data
(60) Provisional application No. 62/250,297, filed on Nov. 3, 2015.

(51) Int. Cl. F24B 1/182; A47J 37/07

(52) U.S. Cl. CPC F24B 1/182; A47J 37/0786; A47J 37/0704

(57) ABSTRACT

A park-style grill shelf for a park-style grill including a shelf portion and a connector portion. The connector portion having a first section, a second section spaced apart a predetermined distance from the first section, and a hanger portion connecting the first section and the second section. The first section of the connector portion is connected to the shelf portion such that the shelf portion is positioned at a substantially right angle relative to the first section of the connector portion. The connector portion of the park-style grill shelf is configured to fit over an upper edge of a side of the park-style grill to provide a convenient work space or storage area for items such as condiments, cooking utensils, and beverages.

### CROSS-REFERENCE TO RELATED APPLICATION

This application claims priority to U.S. Provisional Application Ser. No. 62/250,297, filed on Nov. 3, 2015, the entirety of which is hereby expressly incorporated herein by reference.

### BACKGROUND

Outdoor cooking has enjoyed great popularity for many years. County, state, and national park services often provide outdoor cooking grills for use by those participating in the recreation of the parks. These park-style grills are a tremendous convenience to the recreation enthusiasts, and also a considerable convenience to the park administrators in that they assure that fires, and the accompanying mess, are confined to certain areas. However, because they are exposed to harsh weather conditions, as well as stresses from use by the general public, these park-style grills are typically minimalistic in construction.

Because the park-style grills are minimalistic, they do not have shelves which are common in larger commercial grills. Shelves provide convenient work space or storage areas for items such as condiments, cooking utensils, and beverages.

### BRIEF DESCRIPTION OF THE DRAWINGS

FIG. 1 is a perspective view of a prior art park-style grill.

FIG. 2 is a perspective view of a park-style grill shelf constructed in accordance with embodiments of the present disclosure.

FIG. 3 is a partial cross-sectional diagram depicting the park-style grill shelf disposed on the park-style grill in accordance with embodiments of the present disclosure.

FIG. 4 is a partial cross-sectional diagram of another embodiment of a park-style grill shelf shown disposed on the park-style grill in accordance with embodiments of the present disclosure.

FIG. 5 is a partial cross-sectional diagram of another embodiment of a park-style grill shelf shown mounted on the park-style grill in accordance with embodiments of the present disclosure.

FIGS. 6-8 are perspective views showing the formation of a park-style grill shelf formed from a single piece of sheet material in accordance with embodiments of the present disclosure.

### DETAILED DESCRIPTION OF EXEMPLARY EMBODIMENTS

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. The inventive concepts disclosed herein are capable of other embodiments, or of being practiced or carried out in various ways. Also, it is to be understood that the phraseology and terminology employed herein is for the purpose of description and should not be regarded as limiting the inventive concepts disclosed and claimed herein in any way.

In the following detailed description of embodiments, numerous specific details are set forth in order to provide a more thorough understanding of the inventive concepts. However, it will be apparent to one of ordinary skill in the art that the inventive concepts within the instant disclosure may be practiced without these specific details. In other instances, well-known features have not been described in detail to avoid unnecessarily complicating the instant disclosure. In addition, like reference numerals in the figures represent and refer to the same or similar element or function.

As used herein, the terms “comprises,” “comprising,” “includes,” “including,” “has,” “having,” and any variations thereof, are intended to cover a non-exclusive inclusion. For example, a process, method, article, or apparatus that comprises a list of elements is not necessarily limited to only those elements, and may include other elements not expressly listed or inherently present therein.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B is true (or present).

In addition, use of the “a” or “an” are employed to describe elements and components of the embodiments disclosed herein. This is done merely for convenience and to give a general sense of the inventive concepts. This description should be read to include one or at least one and the singular also includes the plural unless it is obvious that it is meant otherwise.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

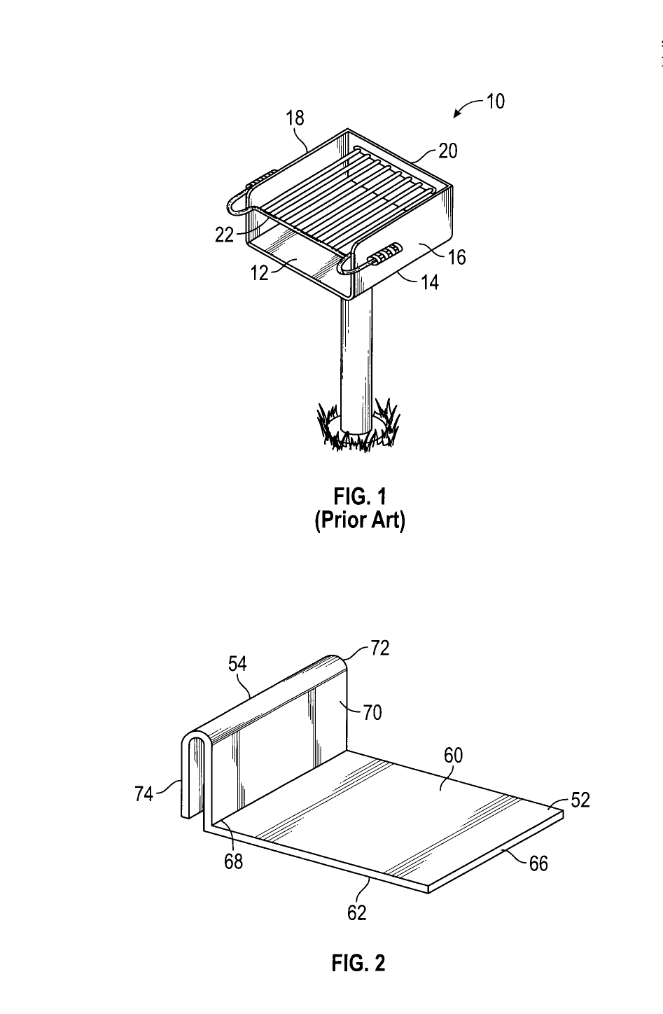

Referring now to the drawings, FIG. 1 illustrates an exemplary embodiment of a park-style grill 10 as is well known in the art. In the embodiment shown, the park-style grill 10 includes a firebox 12 having a bottom 14, a first sidewall 16, a second sidewall 18, a rear wall 20, and a grill 22. The firebox 12 is adapted to receive a cooking fuel such as, for instance, charcoal or wood beneath the grill 22 for cooking purposes.

Referring now to FIG. 2, one embodiment of a park-style grill shelf 50 is shown formed of a single piece of material such as, for instance, aluminum, steel, or stainless steel. In the illustrated embodiment, the park-style grill shelf 50 has a shelf portion 52, a connector portion 54, an upper surface 60, a lower surface 62, an outer edge 66, and a bend 68. The connector portion 54 of the park-style grill shelf 50 has a first section 70, a hanger portion 72, and a second section 74.

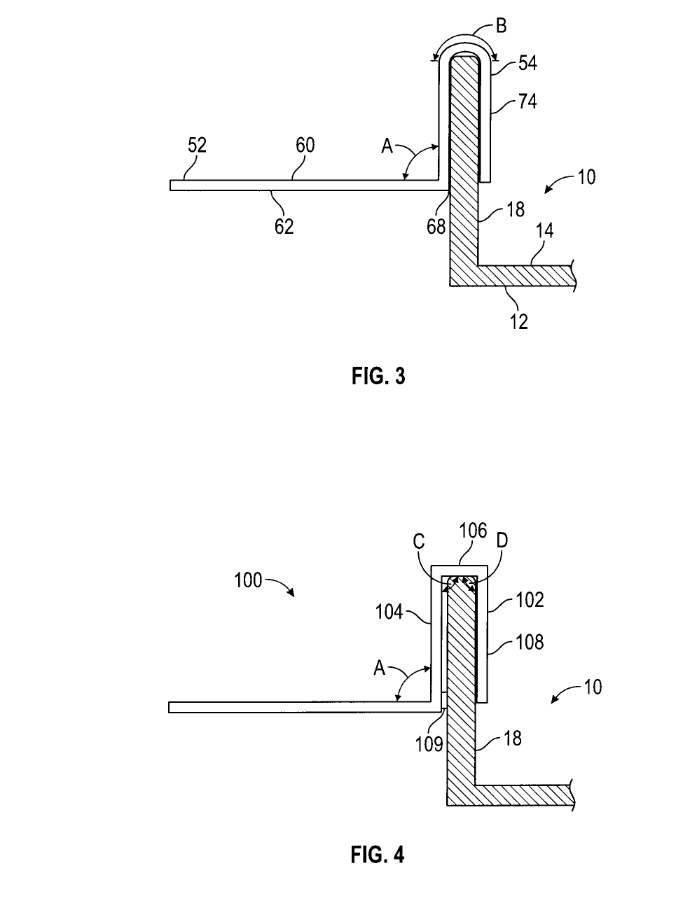

As illustrated in FIG. 2, the upper surface 60 and the lower surface 62 of the shelf portion 52 form substantially planar surfaces. When formed as a one piece unit from a single piece of material, the bend 68 defines an angle A (FIG. 3) having an absolute value of a substantially 90° angle relative to the upper surface 60 of the shelf portion 52 and the upper surface 60 of the first section 70 of the connector portion 54. Or, in other words, the bend 68 forms a right angle. The angle A may have an absolute value in a range from about 85° to about 95°.

As illustrated in FIG. 2, in one embodiment of the park-style grill shelf 50, the upper surface 60 and the lower surface 62 of the first section 70 form substantially planar surfaces. In another embodiment, the upper surface 60 and the lower surface 62 of the first section 70 form convex arcuate surfaces (not shown). In still another embodiment, the upper surface 60 and the lower surface 62 of the first section 70 form concave arcuate surfaces (not shown).

As illustrated in FIG. 3, in one embodiment of the park-style grill shelf 50, the connector portion 54 is formed to fit over an upper edge of the second sidewall 18 of the park-style grill 10 such that the shelf portion 52 extends outwardly away from the park-style grill 10 in a perpendicular relationship to the second sidewall 18. In this embodiment, the hanger portion 72 of the connector portion 54 is radiused forming an arcuate angle B having an absolute value of a substantially 180° angle. The arcuate angle B may have an absolute value in a range from about 170° to about 190°. When the hanger portion 72 is formed as illustrated in FIG. 3, the lower surface 62 of the first section 70 is spaced apart from the lower surface 62 of the second section 74 by in a range of about 1/16 inch to about ½ inch. In an embodiment of the park-style grill shelf 50 where the hanger portion 72 forms an absolute angle of substantially 180°, the lower surface 62 of the first and second sections 70 and 74 will be spaced apart by the same distance along the entire width. However, it will be appreciated by a person of skill in the art that when the hanger portion 72 forms an absolute angle of more or less than 180° the lower surface 62 of the first and second sections 70 and 74 will be spaced apart by distances that differ along the width of the first and second sections 70 and 74.

In the embodiment illustrated in FIG. 3, when the connector portion 54 of the park-style grill shelf 50 is positioned over the upper edge of the second sidewall 18 of the park-style grill 10, at least a portion of the lower surface 62 of the first and second sections 70 and 74 and the hanger portion 72 of the connector portion 54 will be in contact with the second sidewall 18.

Referring now to FIG. 4, another embodiment of a park-style grill shelf 100 is shown connected to the park-style grill 10. In this embodiment, the park style grill shelf 100 is provided with a connector portion 102 having a first section 104, a hanger portion 106, and a second section 108. The hanger portion 106 is defined by two substantially right angles C and D. The angles C and D may have absolute values in a range from about 80° to about 100°. For instance, in one embodiment, the angle D may have an absolute value of 80°, or in other words, angled slightly inward to provide a spring force for resiliently pressing against and frictionally engaging the second sidewall 18 of the park-style grill 10, which is thereby clamped between first and second sections 104 and 108 of the connector portion 102.

The connector portion 102 may also include a spacer element 109 to space the first section 104 from the second sidewall 18 of the park-style grill 10 in a way that reduces the heat transferred to the park-style grill shelf 100 from the second sidewall 18 of the park-style grill 10. The spacer element 109 may be made of a heat insulating material, such as silicone, and the spacer element 109 may be secured to the first section 104 by any suitable means, such as adhesives, bolts, screws, or rivets (not shown).

While the park-style grill shelf 50 and 100 are shown positioned over the upper edge of the second sidewall 18 of the park-style grill 10 in FIGS. 3 and 4, it will be appreciated by a person of skill in the art that the connector portion 54 may be positioned over any one of the first sidewall 16, the second sidewall 18, or the back wall 20.

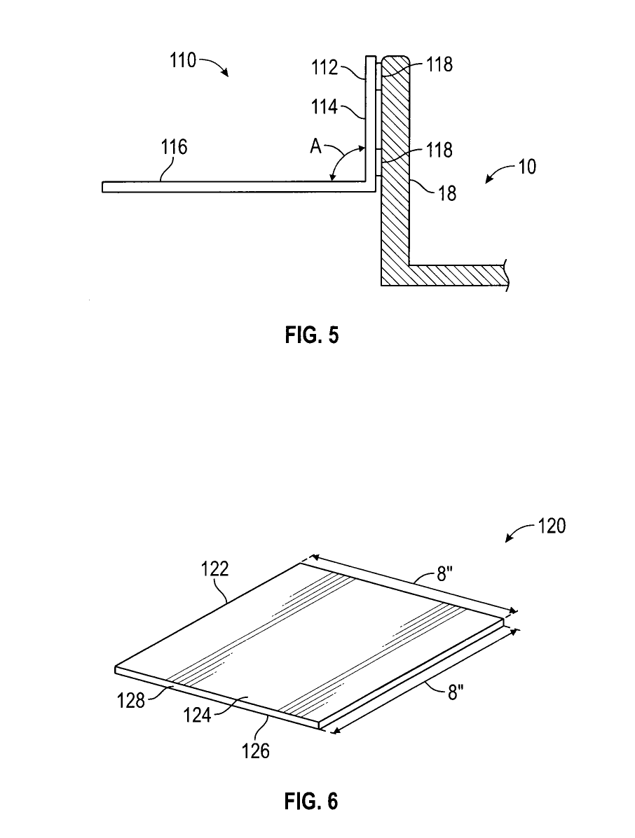

Referring now to FIG. 5, another embodiment of a park-style grill shelf 110 is shown connected to the park-style grill 10. In this embodiment, the park-style grill 110 is provided with a connector portion 112 having a section 114, extending from a shelf portion 116 at an angle A. The angle A may have an absolute value in a range from about 85° to about 95°.

The connector portion 112 is further provided with a plurality of magnets 118 for connecting the park-style grill shelf 110 to the park-style grill 10. As shown in FIG. 5, the magnets 118 are fastened to the section 114 of the connector portion 112 using adhesive. It should be noted, however, that in other embodiments of the park-style grill shelf 110, the magnets 118 may be secured in other ways, such as using bolts, screws, or rivets (not shown).

As illustrated in FIGS. 2-5, in some embodiments the park-style grill shelf 50, 100, and 110 can readily be fabricated from a single piece of sheet material such as, for instance, aluminum, steel, or stainless steel, using conventional metal-forming techniques to produce the park-style grill shelf 50, 100, and 110 without welding or other joining steps. In other embodiments, the park-style grill shelf 50, 100, and 110 may be fabricated using other methods and techniques. For instance, the shelf portion 52 and the connector portion 54 may be formed as separate pieces and fastened together using a fastening method, such as welding.

FIGS. 6-8 show the process of forming a park-style grill shelf 120, which is similar to the park-style grill shelf 50, as a one piece unit from a single piece of sheet material 122 in accordance with some embodiments of the present disclosure. Referring now to FIG. 6 in particular, the sheet material 122 is provided with an upper surface 124, a lower surface 126, and an outer edge 128 and is shown having dimensions of substantially 8 inches by 8 inches.

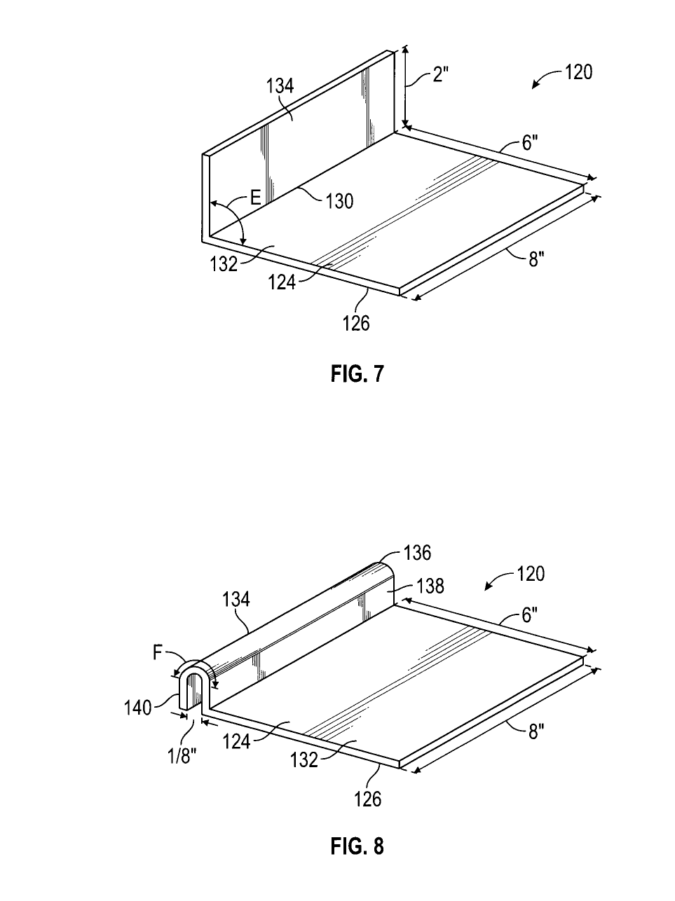

As illustrated in FIG. 7, a bend 130 is formed in the sheet material 122 substantially 6 inches along the upper surface 124 of the sheet material 122. The bend 130 forms an angle E having an absolute angle of substantially 90° relative to the upper surface 124 of the sheet material 122. The bend 130 serves to delineate a shelf portion 132 and a connector portion 134 of the park-style grill shelf 120. In this embodiment, the shelf portion 132 is substantially 6 inches wide and the connector portion 134 is substantially 2 inches wide when measured along the upper surface 124 of the sheet material 122.

FIG. 8 shows a hanger portion 136 formed in the connector portion 134 of the park-style grill shelf 120. The hanger portion 136 of the connector portion 134 is radiused forming an arcuate angle F having an absolute value of a substantially 180° angle. A center of the arcuate angle F is substantially 1 inch from the bend 130 measured along the upper surface 132 of the sheet material 122. In this embodiment, an inside radius of the hanger portion 136 is ⅛ inch. As shown in FIG. 8, the hanger portion 136 separates the connector portion into a first section 138 and a second section 140.

In one embodiment, the park-style grill shelf 120 may be formed of 18 gauge sheet material 122. It should be noted, however, that in other embodiments the sheet material 122 may be 10 gauge, 11 gauge, 12 gauge, 13 gauge, 14 gauge, 15 gauge, 16, gauge, 17 gauge, 18 gauge, 19 gauge, or 20 gauge.

The dimensions used to describe the sheet material 122, the bend 130, and the arcuate angle F of the park-style grill shelf 120 are for illustration purposes only. In other embodiments, the sheet material 122 may be provided having other dimensions and the placement of the bend 130, and the arcuate angle F may be adjusted accordingly.

From the above description, it is clear that the inventive concepts disclosed herein are well adapted to carry out the objects and to attain the advantages mentioned herein, as well as those inherent in the invention. While exemplary embodiments of the inventive concepts have been described for purposes of this disclosure, it will be understood that numerous changes may be made which will readily suggest themselves to those skilled in the art and which are accomplished within the spirit of the inventive concepts disclosed.

What is claimed is:

1. A park-style grill shelf for a park-style grill, the park-style grill shelf comprising:
a shelf portion having an upper surface and a lower surface; and
a connector portion having a first section, a second section spaced apart a predetermined distance from the first section, and a hanger portion connecting the first section and the second section, the first section of the connector portion being connected to the shelf portion such that the shelf portion is positioned at a substantially right angle relative to the first section of the connector portion,
wherein the connector portion is configured to fit over an upper edge of a side of the park-style grill.

2. The park-style grill shelf of claim 1, wherein the hanger portion of the connector portion is radiused forming an arcuate angle having an absolute value of a substantially 180° angle.

3. The park-style grill shelf of claim 1, wherein the hanger portion of the connector portion forms a substantially planar surface positioned at right angles relative to the first section and the second section of the connector portion.

4. The park-style grill shelf of claim 1, wherein the first section of the connector portion forms a concave arcuate surface.

5. The park-style grill shelf of claim 1, wherein the first section of the connector portion forms a convex arcuate surface.

6. The park-style grill shelf of claim 1, wherein the first section is spaced apart from the second section in a range from about 1/16 inch to about ½ inch.

7. The park-style grill shelf of claim 1, wherein the second section of the connector portion is angled slightly inward toward the first section to provide a spring force for resiliently pressing against and frictionally engaging the side of the park-style grill.

8. The park-style grill shelf of claim 1, wherein the first section of the connector portion is provided with a spacer element positioned to space the first section apart from the side of the park-style grill.

9. The park-style grill shelf of claim 1, wherein the shelf portion and the connector portion are formed as a one-piece unit.

10. A park-style grill shelf for a park-style grill, the park-style grill shelf comprising:
a shelf portion having an upper surface and a lower surface;
a connector portion having an upper surface and a lower surface, the connector portion being connected to the shelf portion such that the upper surface of the shelf portion is positioned at a substantially right angle relative to the upper surface of the connector portion;
wherein a plurality of magnets are fastened to the lower surface of the connector portion for connecting the park-style grill shelf to a side of the park-style grill.

11. A park-style grill shelf in combination with a park-style grill, the park-style grill including a firebox with a bottom, a first sidewall, a second sidewall, a rear wall, and a grill, the park-style grill shelf comprising:
a shelf portion having an upper surface and a lower surface; and
a connector portion having a first section, a second section spaced apart a predetermined distance from the first section, and a hanger portion connecting the first section and the second section, the first section of the connector portion being connected to the shelf portion such that the shelf portion is positioned at a substantially right angle relative to the first section of the connector portion,
wherein the connector portion is positioned over an upper edge of one of the first sidewall, the second sidewall, and the rear wall of the park-style grill such that the shelf portion extends outwardly away from the park-style grill.

12. The combination of claim 11, wherein the hanger portion of the connector portion is radiused forming an arcuate angle having an absolute value of a substantially 180° angle.

13. The combination of claim 11, wherein the hanger portion of the connector portion forms a substantially planar surface positioned at right angles relative to the first section and the second section of the connector portion.

14. The combination of claim 11, wherein the first section of the connector portion forms a concave arcuate surface.

15. The combination of claim 11, wherein the first section of the connector portion forms a convex arcuate surface.

16. The combination of claim 11, wherein the first section of the connector portion is spaced apart from the second section in a range from about 1/16 inch to about ½ inch.

17. The combination of claim 11, wherein the second section of the connector portion is angled slightly inward toward the first section to provide a spring force for resiliently pressing against and frictionally engaging the first sidewall, the second sidewall, or the rear wall of the park-style grill.

18. The combination of claim 11, wherein the first section of the connector portion is provided with a spacer element positioned to space the first section apart from the first sidewall, the second sidewall, or the rear wall of the park-style grill.

19. The combination of claim 11, wherein the shelf portion and the connector portion of the park-style grill shelf are formed as a one-piece unit.
